(19) United States
(12) Patent Application Publication
(10) Pub. No.: US 2015/0312028 A1
(43) Pub. Date: Oct. 29, 2015

(54) HOMOMORPHIC ENCRYPTION AND DECRYPTION METHODS USING RING ISOMORPHISM, AND APPARATUSES USING THE SAME

(71) Applicant: SNU R&DB FOUNDATION, Seoul (KR)

(72) Inventors: Jung Hee CHEON, Seoul (KR); Jinsu KIM, Seoul (KR); Moon Sung LEE, Seoul (KR)

(21) Appl. No.: 14/127,478

(22) PCT Filed: Aug. 28, 2013
(86) PCT No.: PCT/KR13/07743

§ 371 Date: Dec. 18, 2013

(30) Foreign Application Priority Data
Aug. 28, 2012 (KR) 10-2012-0094061
Jan. 24, 2013 (KR) 10-2013-0007760

(51) Int. Cl. H04L 9/00

(52) U.S. Cl. CPC H04L 9/008

(57) ABSTRACT

A homomorphic encryption method using ring isomorphism is provided. The homomorphic encryption method includes: randomizing a plaintext (m) by adding an error (e) to the plaintext (m); and converting randomized data (r) to r′ using the following equation: Ψ:R→R′, where r∈R, r′∈R′, and the function (Ψ) is ring isomorphism.

### FIELD

Apparatuses and methods consistent with the exemplary embodiments relate to homomorphic encryption and decryption methods using ring isomorphism, and apparatuses using the same.

### BACKGROUND

The homomorphic encryption technology is encryption technology that allows multiplication or addition of data in an encryption state, and is expected to be utilized in various fields. For example, when privacy needs to be protected, the homomorphic encryption technology can process encrypted data without decrypting it and thus is useful.

The research on fully homomorphic encryption has been actively conducted after the fully homomorphic encryption technology was suggested in 2009. In particular, the integer-based fully homomorphic encryption technology can support addition and multiplication among ciphertexts without limiting how many times the operations are performed. However, the shortcoming of this technology is that a size of a public key is excessively great and much time is required to encrypt.

Also, the other related-art fully homomorphic encryption technologies have problems in that they are not secure and do not support addition or multiplication as many times as a user wants.

### SUMMARY

One or more aspects of the exemplary embodiments provide an encryption apparatus using ring isomorphism and a method thereof, and a decryption apparatus and a method thereof, which are secure, can support addition and multiplication as many times as a user wants, do not give limit to a space of a plaintext, and are efficient in speed and storage capacity.

One or more aspects of the exemplary embodiments also provide a computer readable recording medium which records a program to execute an encryption apparatus using ring isomorphism and a method thereof, and a decryption apparatus and a method thereof, which are secure, can support addition and multiplication as many times as a user wants, do not give limit to a space of a plaintext, and are efficient in speed and storage capacity.

One or more aspects of the exemplary embodiments also provide a refresh apparatus which can achieve bootstrapping without increasing parameters of homomorphic encryption and without squashing.

According to an aspect of an exemplary embodiment, there is provided a homomorphic encryption method using ring isomorphism, the method including: randomizing a plaintext (m) by adding an error (e) to the plaintext (m); and converting randomized data (r) to r′ using the following equation:

Ψ:R→R′

where r∈R, r′∈R′, and the function (Ψ) is a ring isomorphism.

According to an aspect of another exemplary embodiment, there is provided a method for decrypting a ciphertext, the method including: evaluating a ciphertext (c) by applying a key (s) to the ciphertext (c); and calculating a modulo by dividing a value calculated in the evaluating operation by q, wherein the ciphertext (c) is a ciphertext that is encrypted in a homomorphic encryption method using ring isomorphism, wherein the homomorphic encryption method includes converting a plaintext (m) or a randomized plaintext to r′ using the following equation:

Ψ:R→R′

where r is a plaintext (m) or a randomized plaintext, r∈R, r′∈R′, and the function (Ψ) is ring isomorphism,

where q∈Q, Q={qᵢ|1≦i≦k, i and k are positive integers}, each of qᵢ is positive integer which is relatively prime to one another, S={aᵢ|aᵢ−aᵢ∈{Z*ₙ}, 1≦i, j≦k, i, j, and k are positive integers}=(a₁, a₂, . . . , aₖ).

According to an aspect of still another exemplary embodiment, there is provided a homomorphic encryption apparatus using ring isomorphism, the homomorphic encryption apparatus including a converter configured to convert a plaintext or data (r) which is a randomized plaintext to r′ using the following equation:

Ψ:R→R′

where r∈R, r′∈R′, and the function (Ψ) is ring isomorphism.

According to an aspect of still another exemplary embodiment, there is provided an apparatus for decrypting a ciphertext, the apparatus including: an evaluator configured to evaluate a ciphertext (c) by applying a key (s) to the ciphertext (c); and a modulo calculator configured to calculate a modulo by dividing a value calculated by the evaluator by q, wherein the ciphertext (c) is a ciphertext that is encrypted in a homomorphic encryption method using ring isomorphism, wherein the homomorphic encryption method includes encrypting a plaintext or data (r) which is a randomized plaintext into r′ using the following equation:

Ψ:R→R′

where r∈R, r′∈R′, and the function (Ψ) is ring isomorphism.

One of the above-described methods may be provided by a computer readable recording medium which records a program.

According to one or more exemplary embodiments, it is possible to encrypt data up to a secure level, and addition and multiplication of encrypted data can be supported as many times as they are realistically accepted. Also, there is no limit to a space of a plaintext to be encrypted and speed and storage capacity are efficient.

### BRIEF DESCRIPTION OF THE DRAWINGS

The above and other features and advantages will become more apparent by describing in detail exemplary embodiments with reference to the attached drawings in which:

FIG. 1 is a view to illustrate an encryption apparatus using ring isomorphism according to an exemplary embodiment;

FIG. 2 is a view to illustrate a decryption apparatus according to an exemplary embodiment;

FIG. 3 is a view to illustrate a decryption apparatus according to another exemplary embodiment;

FIG. 4 is a view to illustrate an encryption apparatus according to an exemplary embodiment;

FIG. 5 is a view to illustrate a decryption apparatus according to an exemplary embodiment;

FIG. 6 is a view to illustrate a calculation apparatus according to an exemplary embodiment;

FIG. 7 is a view to illustrate an encryption method according to an exemplary embodiment;

FIG. 8 is a view to illustrate an encryption method according to an exemplary embodiment;

FIG. 9 is a view to illustrate a decryption method according to an exemplary embodiment;

FIG. 10 is a view to illustrate a decryption method according to an exemplary embodiment;

FIG. 11 is a view to illustrate an encryption apparatus and a decryption apparatus according to an exemplary embodiment;

FIG. 12 is a view to illustrate an encryption method according to an exemplary embodiment;

FIG. 13 is a view to illustrate a decryption method according to an exemplary embodiment;

FIG. 14 is a view to illustrate an encryption apparatus and a decryption apparatus according to an exemplary embodiment;

FIG. 15 is a view to illustrate an encryption method according to an exemplary embodiment;

FIG. 16 is a view to illustrate a decryption method according to an exemplary embodiment;

FIG. 17 is a view to illustrate a refresh apparatus according to an exemplary embodiment; and

FIG. 18 is a view to illustrate a computer system according to an exemplary embodiment.

### DESCRIPTION OF THE REFERENCE NUMERALS IN THE DRAWINGS

10, 50, 60, 150, 230, 250: modular calculator

20, 120, 220: randomizer

30, 140: converter

40, 130: evaluator

70: addition calculator

80: multiplication calculator

240: CRT calculator

310: refresh apparatus

### DETAILED DESCRIPTION

Exemplary embodiments will now be described more fully with reference to the accompanying drawings to clarify aspects, features and advantages of the inventive concept. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art. It will be understood that when an element is referred to as being “on” another element, the element can be directly on another element or intervening elements.

The terms used herein are for the purpose of describing particular exemplary embodiments only and are not intended to be limiting. As used herein, the singular forms “a”, “an” and “the” are intended to include the plural forms as well, unless the context clearly indicates otherwise. It will be further understood that the terms “comprises” and/or “comprising,” when used in this specification, do not preclude the presence or addition of one or more other components.

Hereinafter, exemplary embodiments will be described in greater detail with reference to the accompanying drawings. The matters defined in the description, such as detailed construction and elements, are provided to assist in a comprehensive understanding of the exemplary embodiments. However, it is apparent that the exemplary embodiments can be carried out by those of ordinary skill in the art without those specifically defined matters. In the description of the exemplary embodiment, certain detailed explanations of related art are omitted when it is deemed that they may unnecessarily obscure the essence of the inventive concept.

### Definition of Terms

When mapping from ring R to ring R′, f:R→R′, satisfies the following two operations for a certain a, b∈R, it is said that the two operations of the ring are preserved, and ‘f’ is referred to as ring homomorphism from R to R′:

f(a+b)=f(a)+f(b), f(ab)=f(a)f(b)

In particular, when ‘f’ is ring homomorphism and also is one-to-one correspondence, ‘f’ is referred as ring isomorphism from R to R′.

### Notation of Set and Elements

In the specification, a set is expressed by a capital and an element is expressed by a small letter for the convenience of explanation, and vector and scalar are expressed by small letters without being distinguished. The set, element, vector, and scalar frequently used herein are expressed as follows:

1) Set: M, R, R′, Q, E, S

2) Element: m, r, r′, q, e, s

where m ∈ M, r ∈ R, r′ ∈ R′, q ∈ Q, e ∈ E, and s ∈ S

3) Vector and Components of Vector

m=(m₁, m₂, . . . , mₖ)

r=(r₁, r₂, . . . , rₖ)

r′=(r′₁, r′₂, . . . , r′ₖ)

q=(q₁, q₂, . . . , qₖ)

e=(e₁, e₂, . . . , eₖ)

s=(a₁, a₂, . . . , aₖ),

where mᵢ is any one of the components of m (that is, m₁, m₂, . . . , mₖ), rᵢ is any one of the components of r (that is, r₁, r₂, . . . , rₖ), r′ᵢ is any one of the components of r′ (that is, r′₁, r′₂, . . . , r′ₖ), qᵢ is any one of the components of q (that is, q₁, q₂, . . . , qₖ), eᵢ is any one of the components of e (that is, e₁, e₂, . . . , eₖ), and aᵢ is any one of the components of s (that is, a₁, a₂, . . . , aₖ).

On the other hand, it should be understood that the set, elements, vector and scalar which are not mentioned herein may be defined and used in the above-described method.

### A. First Exemplary Embodiment

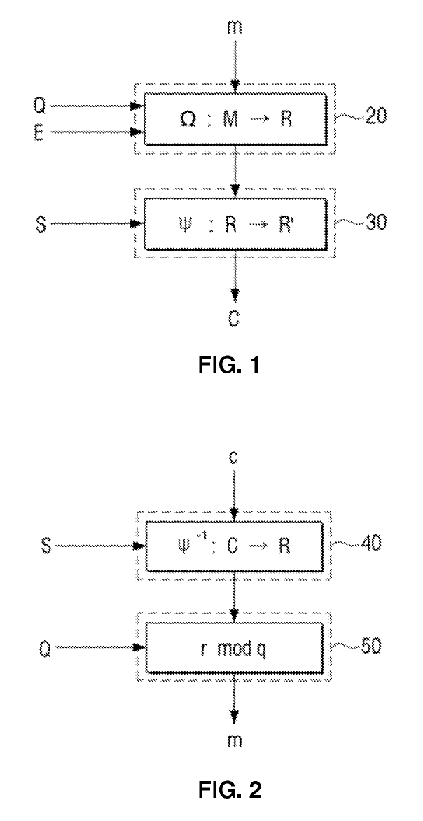

FIG. 1 is a view to illustrate an encryption apparatus using ring isomorphism according to an exemplary embodiment.

Referring to FIG. 1, an encryption apparatus using ring isomorphism according to an exemplary embodiment includes a randomizer 20 and a converter 30.

The randomizer 20 randomizes a plaintext (m) by adding an error (e) to the plaintext. That is, the randomizer 20 adds a certain error (e) belonging to an error space (E) to a certain plaintext (m) belonging to a plaintext space (M), and converts the plaintext (m) into a certain ‘r’ that belongs to R, which is a set of least residues of a modulo n.

The operation of the randomizer 20 may be expressed as equation 1. The plaintext (m) may be either one of vector and scalar, but, in the present exemplary embodiment, it is assumed that the plaintext (m) is scalar for the sake of explanation.

Ω:M→R [Equation 1]

where R=Zn, r ∈ Zn, and Zn is a set of least residues of a modulo n.

r=m+eq=(m+e₁q₁, m+e₂q₂, . . . , m+eₖqₖ)=(r₁, r₂, . . . , rₖ)

where e=(e₁, e₂, . . . , eₖ), q=(q₁, q₂, . . . , qₖ), m ∈ M, e ∈ E, q ∈ Q, and r ∈ R.

In the specification, eq or e·q is a component-wise product of a vector e and a vector q.

According to an exemplary embodiment, when k indicates a dimension of vector, i may be defined as 1≦i≦k

The converter 30 converts data (r) which is randomized by the randomizer 20 into an element (r′) which belongs to a space R′ using a function (Ψ).

The operation of the converter 30 may be expressed as equation 2:

Ψ:R→R′ [Equation 2]

The function (Ψ) used in the converter 30 is ring isomorphism.

An example of the ring isomorphism is the Lagrange interpolation. When the Lagrange interpolation is used in the present exemplary embodiment, R and R′ may be defined as follows:

R=Z^{k}ₙ, R′=Zₙ[x]/(p(x)),

p(x)=Π^{k}ᵢ₌₁(x−aᵢ)=(x−a₁)(x−a₂) . . . (x−aₖ)=p₀+p₁x₁+p₂x₂+ . . . +pₖ₋₁xₖ₋₁

When the Lagrange interpolation is used, the function (Ψ) may be written as follows:

Ψ:Z^{k}ₙ→Zₙ[x]/(P(x))

:(r₁, r₂, . . . , rₖ)→f(x)

where the polynomial f(x) satisfies f(aᵢ)=rᵢ and may be obtained by the Lagrange interpolation

For example, r′ may be a polynomial satisfying:

$$\begin{matrix}f ( {a}_{1} ) = {r}_{1} \\ f ( {a}_{2} ) = {r}_{2} \\ ⋮ \\ f ( {a}_{k} ) = {r}_{k}\end{matrix}$$

Hereinafter, terms and parameters to be used in the present exemplary embodiment will be explained.

a) q=(q₁, q₂, . . . , qₖ), q ∈ Q, qᵢ is integers which are relatively prime to one another, 1≦i≦k, and i and k are positive integers.

b) R=Z^{k}ₙ

Z^{k}ₙ={(r₁, r₂, . . . , rₖ)|rᵢ∈{0, 1, . . . , n−1}, 1≦i≦k, and i, k, n are positive integers.

d) R′=Zₙ[x]/Π^{k}ᵢ₌₁(x−a₁)

g) f(x) is an element of R′ and is defined as follows:

f(x)=b₀+b₁x¹+b₂x₂+ . . . +bₖ₋₁x^{k-1}, bᵢ∈{0, 1, . . . , n−1}

f) p(x) is defined as follows:

p(x)=p₀+p₁x₁+p₂x₂+ . . . +pₖ₋₁xₖ₋₁, pᵢ∈{0, 1, . . . , n−1}

h) a=(a₁, a₂, . . . , aₖ), a∈S, aᵢ−aⱼ∈Z*ₙ, 1≦i, j≦k

i) Z*ₙ is a set of elements in which an inverse element of Zₙ exists, and Zₙ is a set of residues of a modulo n.

The ‘n’ is a positive integer satisfying the following conditions and a size of the ‘n’ varies according to a number of times that multiplication is supported:

Space of a plaintext space (M)<space of q<n

where the size refers to a size of an integer.

In the present exemplary embodiment, Ψ is a secret and q=(q₁, q₂, . . . , qₖ) may be published.

In the present exemplary embodiment, it is assumed that the plaintext (m) is scalar, but exemplary embodiments may be applied when the plaintext (m) is vector.

Ω:M→R

When the plaintext (m) is (m₁, m₂, . . . , mⱼ), r(r∈R) which is converted by Ω may be written as follows:

r=m+eq=(m₁+e₁q₁, m₂+e₂q₂, . . . , mⱼ+eⱼqⱼ, . . . , m+eₖqₖ)=(r₁, r₂, . . . , rₖ), mⱼ∈M, eⱼ∈E, qᵢ∈Q, and rⱼ₊₁, . . . , rₖ is a random value of Zₙ.

On the other hand, the degree (j) of the plaintext should satisfy j≦k. When the degree (j) of the plaintext is less than k, the randomizer 20 adds randomized values rⱼ₊₁, . . . , rₖ, lets the plaintext be k number of degrees, and then randomizes the plaintext.

In the above-described exemplary embodiment, the Lagrange interpolation is used. However, according to another exemplary embodiment, the encryption apparatus using the Chinese Remainder Theorem as ring isomorphism may include a modulo calculator (not shown), a randomizer (not shown), and a converter (not shown).

The modulo calculator (not shown) may perform the following equation:

m′=m mod q

where m is a plaintext, q=(q₁, q₂, . . . , qₖ), and q₁, q₂, . . . , qₖ are positive integers which are relatively prime to one another.

The randomizer (not shown) may randomize the m′ which is calculated by the above-described modulo calculator by applying equation 1 as follows:

r=m′+eq=(m′+e₁q₁, m′+e₂q₂, . . . , m′+eₖqₖ)=(r₁, r₂, . . . , rₖ)

The converter (not shown) may convert the data (r) randomized by the randomizer (not shown) into r′ using the Chinese Remainder Theorem. The operation of the converter (not shown) may be expressed as following equation:

c=CRT_{S}(r) [Equation 3]

where CRT is an operator applying the Chinese Remainder Theorem, s is a key satisfying s=(a₁, a₂, . . . , aₖ), and k is a number of keys. According to an exemplary embodiment, the key may be a secret key.

The CRT indicates that, when a₁, a₂, . . . , aₖ are integers which are relatively prime to one another and b=a₁·a₂·a₃ . . . aₖ, c satisfying c=rₖ (mod aₖ) for a certain progression r₁, r₂, . . . , rₖ uniquely exists as mod s.

The simultaneous congruence on ‘c’ may be written as follows:

$$\begin{matrix}c = {r}_{1} ( mod {a}_{1} ) \\ c = {r}_{2} ( mod {a}_{2} ) \\ ⋮ \\ c = {r}_{k} ( mod {a}_{k} )\end{matrix}$$

In the equation CRT_{S}(r), r is a remainder, s is a divisor, and c which is a value of the equation CRTₛ(r) is a value satisfying the above simultaneous congruence.

The components of the secret key ‘s’, a₁, a₂, . . . , aₖ, are selected such that all qᵢ is relatively prime to b. The b is defined as a product of a₁ to aₖ as follows:

b=a₁·a₂·a₃ . . . aₖ

The converter (not shown) performs calculation by applying the secret key s=(a₁, a₂, . . . , aₖ), and thus performs encryption secure from an attacker that does not know the secret key. The system according to the exemplary embodiments can be regarded as a secure encryption system as long as an error-free approximate greatest common divisor problem (EACDP) is safe.

Although the encryption apparatus using the Chinese Remainder Theorem includes the modulo calculator as described above, the encryption apparatus may include the randomizer and the converter, but may not include the modulo calculator.

When the encryption apparatus does not include the modulo calculator, the randomizer randomizes the plaintext (m) by applying equation 1:

r=m+eq=(m+e₁q₁, m+e₂q₂, . . . , m+eₖqₖ)=(r₁, r₂, . . . , rₖ)

The converter converts the data (r) randomized by the randomizer into c using the Chinese Remainder Theorem as follows:

c=CRTₛ(r)

### B. Second Exemplary Embodiment

FIG. 2 is a view to illustrate an apparatus for decrypting a ciphertext which is encrypted in a homomorphic encryption method using ring isomorphism according to an exemplary embodiment.

Referring to FIG. 2, a decryption apparatus according to an exemplary embodiment includes an evaluator 40 and a modulo calculator 50.

The evaluator 40 evaluates a ciphertext (c) which is encrypted in a homomorphic encryption method using ring isomorphism by applying a key (s) to the ciphertext.

The evaluator 40 may perform an operation as the following equation 4:

Ψ⁻¹:C→R [Equation 4]

where c∈C, c is a ciphertext which is encrypted according to the first exemplary embodiment described above with reference to FIG. 1, and Ψ⁻¹ is an inverse function of Ψ.

When the ciphertext is a polynomial f(x) and the plaintext which has not been encrypted is scalar (m), the evaluator 40 calculates f(a₁) from f(x) based on equation 4.

When the ciphertext is a polynomial f(x) and the plaintext which has not been encrypted is vector (m₁, m₂, . . . , mⱼ), the evaluator 40 calculates (f(a₁), f(a₂), . . . , f(aⱼ)) from f(x) based on equation 4.

The modulo calculator 50 may perform an operation as the following equation 5:

r mod q [Equation 5]

where r∈R, and the modulor calculator 50 may calculate a modulo by dividing the value (r) which is evaluated by the evaluator 40 by q, such that the plaintext (m) is generated.

When the ciphertext is a polynomial f(x) and the plaintext is scalar (m), the decrypting process of the decryption apparatus according to the present exemplary embodiment may be summarized as follows:

Dec(c)=f(a₁) mod q₁=m

When the ciphertext is a polynomial f(x) and the plaintext is vector (m), the decrypting process of the decryption apparatus according to the present exemplary embodiment may be summarized as follows:

Dec(c)=(f(a₁), f(a₂), . . . , f(aⱼ)) mod q=(f(a₁) mod q₁, f(a₂) mod q₁, . . . , f(aⱼ) mod qⱼ)=(m₁, m₂, . . . , mⱼ)

In the above-described exemplary embodiment, the decryption apparatus decrypts the ciphertext encrypted using the Lagrange interpolation.

According to another exemplary embodiment, the decryption apparatus may decrypt a ciphertext encrypted using the Chinese Remainder Theorem described above with reference to FIG. 1.

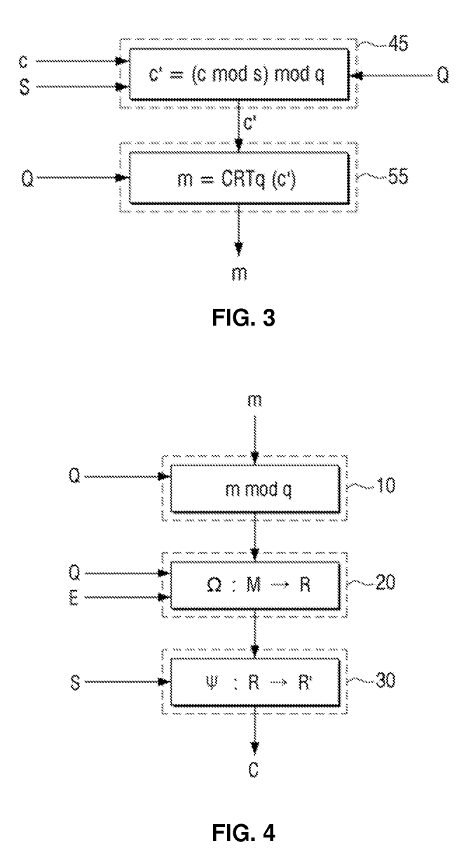

FIG. 3 is a view to illustrate an apparatus for decrypting a ciphertext which is encrypted in a homomorphic encryption method using ring isomorphism according to another exemplary embodiment.

With reference to FIG. 3, a decryption apparatus may include a modulo calculator 45 and a Chinese Remainder Theorem (CRT) calculator 55. The modulo calculator 45 may perform an operation expressed by the following equation:

c′=(c mod s) mod q

where c is a ciphertext which is encrypted by applying the Chinese Remainder Theorem, s is a secret key and s=(a₁, a₂, . . . , aₖ), and q=(q₁, q₂, . . . , qₖ), and the conditions of the secret key s and q have been described above with reference to FIG. 1 and thus an explanation thereof is omitted.

The CRT calculator 55 calculates a plaintext (m) by performing an operation expressed by the following equation:

m=CRTq(c′)

The method for calculating the CRTq(c′) has been described above with reference to FIG. 1 and an explanation thereof is omitted here.

The decryption apparatus described above with reference to FIG. 3 performs modulo calculation with respect to the plaintext (m), calculates r by randomizing the result of the modulo calculation, m′, and converts the randomized r into r′ using the Chinese Remainder Theorem.

The encryption apparatus according to an exemplary embodiment omits the process of calculating the modulo for the plaintext (m) and directly randomizes the plaintext (m) and then calculates the ciphertext using the Chinese Remainder Theorem. The decryption apparatus for decrypting such an encrypted ciphertext includes a modulo calculator 45 and a CRT calculator 55.

That is, the modulo calculator 45 performs the following equation:

c′=(c mod s) mod q

The CRT calculator 55 calculates the plaintext (m) by applying the Chinese Remainder Theorem to c′ as in the following equation:

m=CRTq(c′)

### C. Third Exemplary Embodiment

FIG. 4 is a view to illustrate an encryption apparatus using ring isomorphism according to an exemplary embodiment.

Referring to FIG. 4, an encryption apparatus using ring isomorphism according to an exemplary embodiment includes a modulo calculator 10, a randomizer 20, and a converter 30.

The modulo calculator 10 performs modulo calculation by dividing a plaintext (m) by q.

When a plaintext (m′) calculated by the modulo calculator 10 is m′=(m₁, m₂, . . . , mₖ), and a space to which the plaintext (m′) belongs is M, the randomizer 20 may perform the following calculation:

Ω:M→R

That is, the randomizer 20 converts m′ into one element (r) belonging to the space R by applying the function Ω to m′.

Herein, m′∈M, r∈R, and r=m′+eq=(m′₁+e₁q₁, m′₂+e₂q₂, . . . , m′ₖ+eₖqₖ)=(r₁, r₂, . . . , rₖ)

The converter 30 performs the following calculation using a ring isomorphism function (Ψ):

Ψ:R→R′

Since the functions of the randomizer 20 and the converter 30 are identical or similar to those of the first exemplary embodiment, a detailed description thereof is omitted. Also, since q, e, s, R, R′, Ψ, and Ω are identical or similar to those of the first exemplary embodiment, a detailed description thereof is omitted.

In the present exemplary embodiment, the converter 30 may perform conversion using the Lagrange interpolation or the Chinese Remainder Theorem. The conversion using the Lagrange interpolation or the Chinese Remainder Theorem has been described above with reference to FIG. 1 and thus a detailed description thereof is omitted.

### D. Fourth Exemplary Embodiment

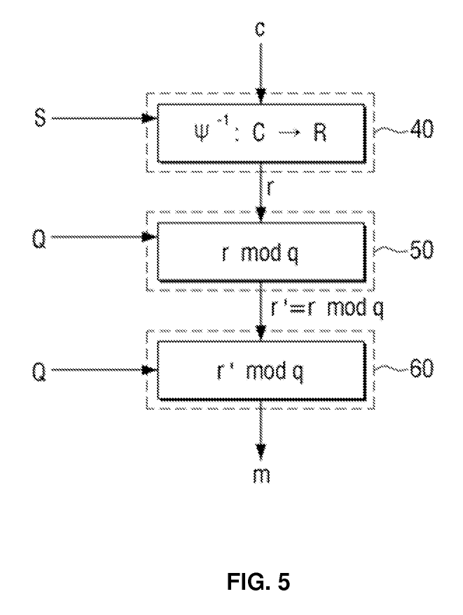

FIG. 5 is a view to illustrate an apparatus for decrypting a ciphertext which is encrypted in a homomorphic encryption method using ring isomorphism according to an exemplary embodiment.

Referring to FIG. 5, a decryption apparatus includes an evaluator 40, a first modulo calculator 50, and a second modulo calculator 60.

The evaluator 40 evaluates a ciphertext which is encrypted in the method described in the exemplary embodiment described above with reference to FIG. 4 as follows:

Ψ⁻¹:C→R

The first modulo calculator 50 calculates a modulo by dividing a value (r) which is evaluated by the evaluator 40 by q.

The second modulo calculator 60 calculates a modulo by diving the value calculated by the first modulo calculator 50 by q again, such that a plaintext (m) is generated.

Herein, the evaluator 40 and the first modulo calculator 50 are identical or similar to those of the above-described third exemplary embodiment in their functions, and thus a detailed description thereof is omitted.

### E. Fifth Exemplary Embodiment

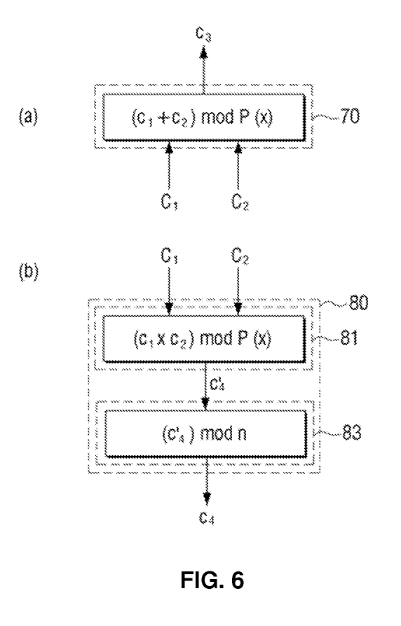

FIG. 6 is a view to illustrate a calculation apparatus for calculating a ciphertext which is encrypted in an encryption method according to an exemplary embodiment. The ‘calculation apparatus’ may be implemented by using an encryption apparatus, a decryption apparatus, or an encryption and decryption apparatus according to an exemplary embodiment.

View (a) of FIG. 6 is to illustrate addition and view (b) of FIG. 6 is to illustrate multiplication.

Referring to view (a) of FIG. 6, the calculation apparatus according to an exemplary embodiment may include an addition calculator 70 and/or a multiplication calculator 80.

The addition calculator 70 may perform addition according to the following equation:

(c₁+c₂) mod p(x)

The multiplication calculator 80 may perform multiplication according to the following equation:

((c₁c₂) mod p(x)) mod n

where c₁ and c₂ are ciphertexts which are encrypted in the methods described in the above-described first (A) and third (C) exemplary embodiments, and p(x) and n are used when c₁ and c₂ are encrypted.

According to an exemplary embodiment, the calculation apparatus may include at least one of the addition calculator 70 and the multiplication calculator 80, and the addition calculator 70 and the multiplication calculator 80 may be implemented as hardware and/or software.

### F. Sixth Exemplary Embodiment

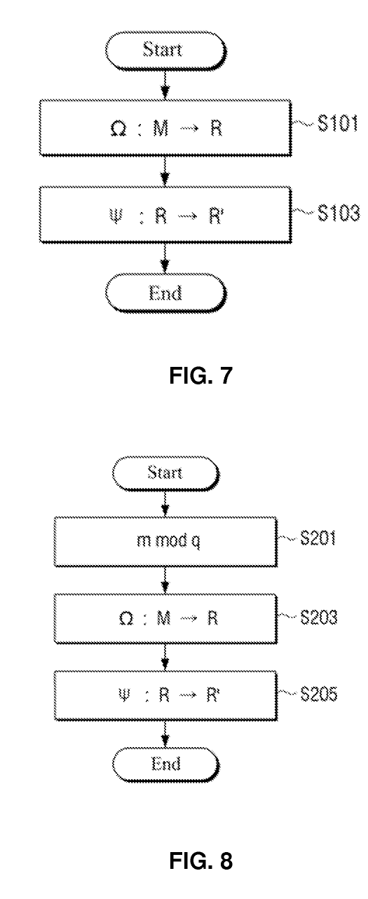

FIG. 7 is a view to illustrate an encryption method using ring isomorphism according to an exemplary embodiment.

Referring to FIG. 7, an encryption method using ring isomorphism according to an exemplary embodiment may include randomizing (S101) and converting (S103).

The randomizing (S101) is randomizing a plaintext (m) by adding an error (e) to the plaintext (m).

The randomizing (S101) may be randomizing a plaintext (m) using equation 1, for example.

The randomizing (S101) may be performed by the randomizer 20 of the above-described first exemplary embodiment, for example.

The randomizing (S101) may perform r=m+eq, which has been described in detail in the first exemplary embodiment.

The converting (S103) may convert data (r) which is randomized in the randomizing (S101) into a ciphertext using a function (Ψ). The function (Ψ) used in the converting (S103) is ring isomorphism.

The function (Ψ) used in the converting (S103) may be the Lagrange interpolation or the Chinese Remainder Theorem, for example. The converting (S103) may be performed by the converter 30 of the above-described first exemplary embodiment, for example.

Regarding S101 and S103, please refer to the first exemplary embodiment.

### G. Seventh Exemplary Embodiment

FIG. 8 is a view to illustrate an encryption method using ring isomorphism according to an exemplary embodiment.

Referring to FIG. 8, an encryption method using ring isomorphism according to an exemplary embodiment includes calculating a modulo (S201), randomizing (S201), and converting (S203).

Comparing the exemplary embodiment of FIG. 7, the exemplary embodiment of FIG. 8 further includes only the calculating the modulo (S201). The operations performed in the randomizing (S203) and the converting (S205) of FIG. 8 may be identical or similar to the operations performed in the randomizing (S101) and the converting (S103) of FIG. 7, respectively.

The calculating the modulo (S201) may be calculating the modulo by dividing a plaintext (m) by q.

The randomizing (S203) may be randomizing the plaintext using equation 1, for example. The randomizing (S203) may be performed by the randomizer 20 of the above-described first exemplary embodiment, for example.

The randomizing (S203) may perform the following operation:

Ω:M→R

where (m mod q)∈M, r∈R, and r=m+eq. Regarding these, please refer to the first exemplary embodiment.

The converting (S205) may be converting data (r) which is randomized in the randomizing (S203) into a ciphertext using a function (Ψ). The function (Ψ) used in the converting (S205) is ring isomorphism.

The function (Ψ) used in the converting (S205) may be the Lagrange interpolation or the Chinese Remainder Theorem.

The converting (S205) may be performed by the converter 30 of the above-described first exemplary embodiment.

### H. Eighth Exemplary Embodiment

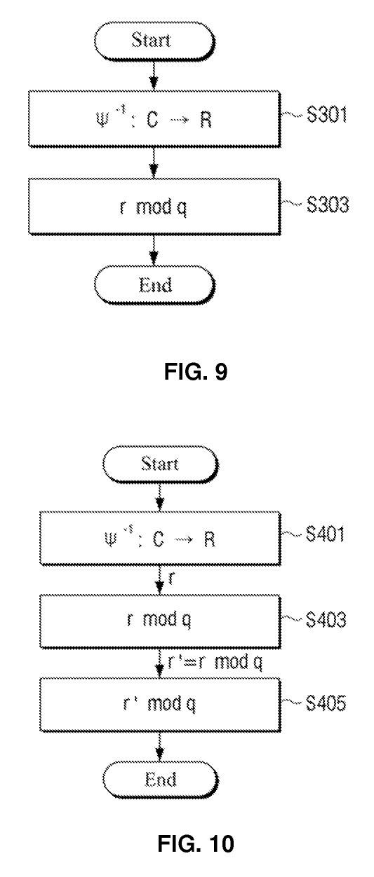

FIG. 9 is a view to illustrate a method for decrypting a ciphertext which is encrypted in a homomorphic encryption method using ring isomorphism according to an exemplary embodiment.

Referring to FIG. 9, the decryption apparatus may include evaluating (S301) and calculating a modulo (S303).

The evaluating (S301) may be evaluating a ciphertext (c) which is encrypted in the homomorphic encryption method using the ring isomorphism by applying a key (s) to the ciphertext (c).

The evaluating (S301) may perform the following calculation:

Ψ⁻¹:C→R

where c∈C and c is a ciphertext which is encrypted by the first exemplary embodiment described above with reference to FIG. 1, R and Ψ are as defined in the first exemplary embodiment, and Ψ⁻¹ is an inverse function of Ψ.

When the ciphertext (c) is a polynomial f(x) and a plaintext (m) which has not been encrypted is scalar, the evaluating (S301) may calculate f(a₁) from f(x).

When the ciphertext (c) is a polynomial f(x) and the plaintext (m) which has not been encrypted is vector ((m₁, m₂, . . . , mⱼ)), the evaluating (S301) may calculate (f(a₁), f(a₂), . . . , f(aⱼ)) from f(x).

The evaluating (S301) may be performed by the evaluator 40 of the above-described second exemplary embodiment, for example.

The calculating the modulo (S303) may be calculating r mod q.

That is, the calculating the modulo (S303) may be calculating the modulo by dividing the value (r) which is evaluated in the evaluating (S301) by q, such that the plaintext (m) is generated.

The calculating the modulo (S303) may be performed by the modulo calculator 50 of the above-described second exemplary embodiment, for example.

### I. Tenth Exemplary Embodiment

FIG. 10 is a view to illustrate a method for decrypting a ciphertext which is encrypted in a homomorphic encryption method using ring isomorphism according to an exemplary embodiment.

Referring to FIG. 10, the decryption method may include evaluating (S401), calculating a first module (S403), and calculating a second modulo (S405). Comparing the exemplary embodiment of FIG. 9, the exemplary embodiment of FIG. 10 further includes the calculating the second modulo (S405).

The evaluating (S401) may be evaluating a ciphertext (c) which is encrypted in the homomorphic encryption method using the ring isomorphism by applying a key (s) to the ciphertext (c).

The evaluating (S401) may perform the following calculation:

Ψ⁻¹:C→R

where c∈C and c is a ciphertext which is encrypted by the above-described third exemplary embodiment, R and Ψ are as defined in the first exemplary embodiment, and Ψ⁻¹ is an inverse function of Ψ.

The operation in the evaluating (S401) is identical or similar to the operation in the evaluating (S301) of FIG. 9 and thus a detailed description thereof is omitted.

The calculating the first modulo (S403) may be calculating the modulo by dividing the value (r) which is evaluated by the evaluating (S401) by q. The operation in the calculating the first modulo (S403) is identical or similar to the operation in the calculating the modulo (S303) of FIG. 9 and thus a detailed description is omitted.

The calculating the second modulo (S405) may be calculating the modulo by dividing the value (r) which is calculated in the calculating the first modulo (S403) by q, such that the plaintext (m) is calculated.

### J. Eleventh Exemplary Embodiment

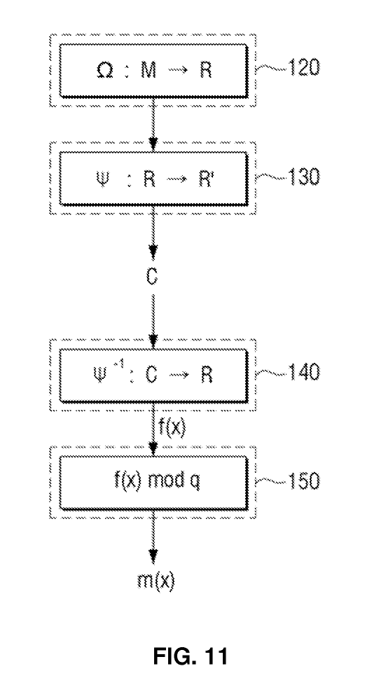

FIG. 11 is a view to illustrate an encryption apparatus and a decryption apparatus using ring isomorphism according to an exemplary embodiment.

Referring to FIG. 11, an encryption apparatus using ring isomorphism according to an exemplary embodiment may include a randomizer 120 and an evaluator 130.

The randomizer 120 may randomize a plaintext using the following equation 6:

Ω:M→R [Equation 6]

where m(x)∈M, m(x) is a polynomial and is given by m(x)=m₀+m₁x¹+ . . . +mₖ₋₁x^{k-1}, and r is written as follows:

r=m(x)+qe(x)

The evaluator 130 may convert the data (r) which is randomized by the randomizer 120 into a ciphertext using the following function (Ψ):

Ψ:R→R′

where the function (Ψ) is ring isomorphism, r∈R, and r′∈R′.

An example of the ring isomorphism is the Lagrange interpolation, and, when the Lagrange interpolation is used in the present exemplary embodiment, R and R′ may be defined as follows:

$$R = {Z}_{n} [ x ] / ( p ( x ) ) , {R}^{′} = {Z}_{n}^{k} , p ( x ) = {\prod }_{i = 1}^{k} ( x - {a}_{i} ) = ( x - {a}_{1} ) ( x - {a}_{2} ) … ( x - {a}_{k} ) = {p}_{0} + {p}_{1} {x}_{1} + {p}_{2} {x}_{2} + … + {p}_{k - 1} {x}_{k - 1}$$

f(x) is one element of R and the evaluator 130 calculates c from f(x). Herein, c=(c₁, c₂, . . . , cₖ)=(m(a₁)+Qe(a₁), m(a₂)+Qe(a₂), . . . , m(aₖ)+Qe(aₖ)).

Herein, Qe(x) is a product of Q and e(x) and terms and/or parameters will be explained below with reference to FIG. 11:

m(x)=m₀+m₁x¹+ . . . +mₖ₋₁x^{k-1}

where mᵢ∈{0, 1, . . . , Q−1}, Q∈{0, 1, . . . , n−1}, and n is a positive integer.

e(x)=e₀+e₁x+e₂x²+ . . . +eₖ₋₁x^{k-1}

where eᵢ∈{0, 1, . . . , E−1}, E∈{0, 1, . . . , n−1}, and n is a positive integer.

R=Z[x]ₙ/Π^{k}ᵢ₌₁(x−aᵢ)

where f(x) which is an element of R is defined as follows:

f(x)=b₀+b₁x¹+b₂x₂+ . . . +bₖ₋₁x^{k-1}, bᵢ∈{0, 1, . . . , n−1}

where p(x) is defined as follows:

p(x)=p₀+p₁x₁+p₂x₂+ . . . +pₖ₋₁xₖ₋₁, pᵢ∈{0, 1, . . . , n−1}

On the other hand, p(x) may be written as follows:

p(x)=Π^{k}ᵢ₌₁(x−aᵢ)=(x−a₁)(x−a₂) . . . (x−aₖ)

a, which is an element of S, may be defined as follows:

a=(a₁, a₂, . . . , aₖ), a∈S, aᵢ−aⱼ∈Z*ₙ

where Z*ₙ is a set of elements in which inverse elements of Zₙ exist, and Zₙ is a set of residues of the modulo n.

R′=Z^{k}ₙ={(r₁, r₂, . . . , rₖ)|rᵢ∈{0, 1, . . . , n−1}, 1≦i≦k, and i, k, and n are positive integers}.

A space of a coefficient of the plaintext (m(x)), a space of Q, a space of E, and n have the following relationships:

Space of coefficient of plaintext (m(x))<space of Q<n

Space of coefficient of plaintext (m(x))<space of E<n

Referring back to FIG. 11, the decryption apparatus according to the present exemplary embodiment may include a converter 140 and a modulo calculator 150.

The converter 140 may perform the following operation:

Ψ⁻¹:C→R

where f(x)∈R, c∈C, c=(m(a₁)+qe(a₁), m(a₂)+qe(a₂), . . . , m(aₖ)+qe(aₖ))=(c₁, c₂, . . . , cₖ), f(x) is a polynomial, and Ψ⁻¹ is an inverse function of Ψ.

For example, the polynomial f(x) is a polynomial satisfying f(aᵢ)=cᵢ and is obtained by the Lagrange interpolation. That is, the polynomial (f(x)) converted by the converter 140 satisfies the following conditions:

$$\begin{matrix}f ( {a}_{1} ) = {c}_{1} \\ f ( {a}_{2} ) = {c}_{2} \\ ⋮ \\ f ( {a}_{k} ) = {c}_{k}\end{matrix}$$

The modulo calculator 150 may calculate the modulo by dividing the polynomial f(x) calculated by the converter 140 by Q, such that the plaintext (m) is generated.

When the polynomial f(x) calculated by the converter 140 is f(x)=f₀+f₁x¹+ . . . +fₖ₋₁x^{k-1}, the plaintext generated by the modulo calculator 150 may be written as follows:

m=f₀ mod Q+f₁x¹ mod Q+ . . . +fₖ₋₁x^{k-1} mod Q

### K. Twelfth Exemplary Embodiment

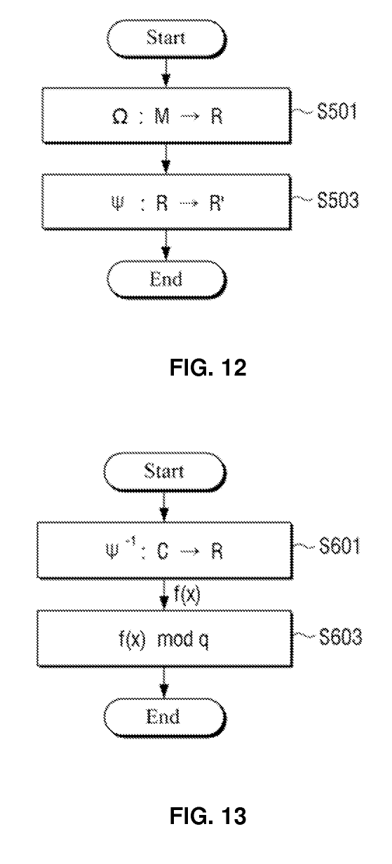

FIG. 12 is a view to illustrate an encryption method using ring isomorphism according to an exemplary embodiment.

Referring to FIG. 12, an encryption method using ring isomorphism according to an exemplary embodiment may include randomizing (S501) and evaluating (S503).

The randomizing (S501) may perform the following operation:

Ω:M→R

where m(x)∈M, and a plaintext (m(x)) which is a polynomial is converted into r(x). The plaintext may be given by m(x)=m₀+m₁x¹+ . . . +mₖ₋₁x^{k-1}.

The randomizing (S501) may be randomizing the plaintext (m(x)) using the above equation 5, for example. The plaintext (m(x)) may be a polynomial.

The operation performed in the randomizing (S501) may be identical or similar to the operation performed by the randomizer 120 of the above-described 11^{th} exemplary embodiment.

The evaluating (S503) may convert the data (R) which is randomized by the randomizing (S501) into a ciphertext using the function (Ψ).

The function (Ψ) used in the evaluating (S503) is ring isomorphism and performs the following operation:

Ψ:R→R′

The operation performed in the evaluating (S503) may be identical or similar to the operation performed by the evaluator 130 of the above-described 11^{th} exemplary embodiment.

### L. Thirteenth Exemplary Embodiment

FIG. 13 is a view to illustrate a decryption method using ring isomorphism according to an exemplary embodiment.

Referring to FIG. 13, a method for decrypting a ciphertext which is encrypted in a homomorphic encryption method using ring isomorphism according to an exemplary embodiment includes converting a ciphertext into a polynomial (S601), and calculating a modulo (S603).

For example, the converting (S601) may be identical or similar to the operation of the converter 140 of FIG. 11, and the calculating the modulo (S603) may be identical or similar to the operation of the modulo calculator 150 of FIG. 11.

The converting (S601) may perform the following operation:

Ψ⁻¹:C→R

where c∈C, c=(m(a₁)+Qe(a₁), m(a₂)+Qe(a₂), . . . , m(aₖ)+Qe(aₖ))=(c₁, c₂, . . . , cₖ), f(x)∈R, f(x) is a polynomial, and Ψ⁻¹ is an inverse function of Ψ.

For example, the polynomial f(x) is a polynomial satisfying f(aᵢ)=cᵢ and is obtained by the Lagrange interpolation. That is, the polynomial (f(x)) calculated in the converting (S601) satisfies the following conditions:

$$\begin{matrix}f ( {a}_{1} ) = {c}_{1} \\ f ( {a}_{2} ) = {c}_{2} \\ ⋮ \\ f ( {a}_{k} ) = {c}_{k}\end{matrix}$$

The calculating the modulo (S603) may be calculating the modulo by dividing the polynomial f(x) calculated in the converting (S601) by Q, such that the plaintext (m) is generated.

When the polynomial f(x) calculated in the converting (S601) is f(x)=f₀+f₁x¹+ . . . +fₖ₋₁x^{k-1}, the plaintext generated in the calculating the modulo (S603) may be written as follows:

m=f₀ mod Q+f₁x¹ mod Q+ . . . +fₖ₋₁xₖ₋₁ mod Q

### M. Fourteenth Exemplary Embodiment

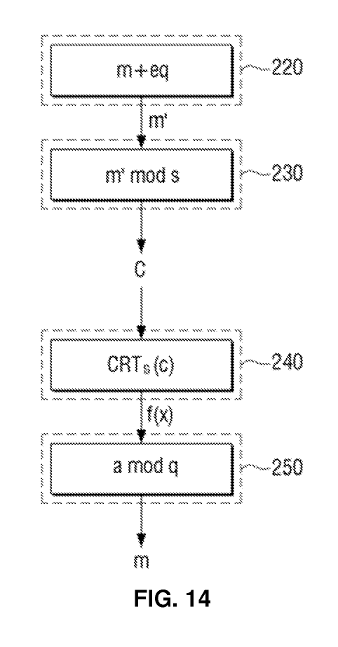

FIG. 14 is a view to illustrate an encryption apparatus and a decryption apparatus using ring isomorphism according to an exemplary embodiment.

Referring to FIG. 14, an encryption apparatus using ring isomorphism according to an exemplary embodiment may include a randomizer 220 and a first modulo calculator 230.

The encryption apparatus converts a plaintext (m) into a ciphertext (c), and c is calculated in the form of (c₁, c₂, . . . , cₖ).

The randomizer 220 performs an operation m+eq with respect to the plaintext (m). Herein, e=(e₁, e₂, . . . , eₖ), q=(q₁, q₂, . . . , qₖ), and eᵢ and qᵢ are integers. eᵢ is an integer of λbit, p=2λ, and λ is a security parameter.

The first modulo calculator 230 performs an operation (m+eq) mod s with respect to m+eq.

The secret key s=(a₁, a₂, . . . , aₖ), and aᵢ is one of a₁, a₂, . . . , aₖ, which are integers relatively prime to one another.

As a result of calculating by the first modulo calculator 230, the ciphertext is calculated in the form of c=(c₁, c₂, . . . , cₖ).

Referring back to FIG. 14, a decryption apparatus using ring isomorphism according to an exemplary embodiment will be explained.

The decryption apparatus may include a CRT calculator 240 and a second modulo calculator 250.

The CRT calculator 240 outputs a value by applying the Chinese Remainder Theorem to the ciphertext (c) using the following equation 7, and the output value may have the form of m+eq:

CRTₛ(c) [Equation 7]

where CRT is a function applying the Chinese Remainder Theorem (an example of ring isomorphism), S is a key satisfying S={aᵢ|1≦i≦k, i and k are positive integers}, and k is a number of keys. According to an exemplary embodiment, the key may be a secret key.

The CRT indicates that, when a₁, a₂, . . . , aₖ are integers which are relatively prime to one another and b=a₁·a₂·a₃ . . . aₖ, c satisfying c=aₖ(mod aₖ) for a certain progression a₁, a₂, . . . , aₖ uniquely exists as mod s.

The simultaneous congruence of c may be written as follows:

$$\begin{matrix}c = {a}_{1} ( mod {a}_{1} ) \\ c = {a}_{2} ( mod {a}_{2} ) \\ ⋮ \\ c = {a}_{k} ( mod {a}_{k} )\end{matrix}$$

In the equation CRTₛ(c), c is a remainder, s is a divisor, and a value of the equation CRTₛ(c) satisfies the above simultaneous congruence.

s is a secret key and s=(a₁, a₂, . . . aₖ), and aᵢ are integers which are relatively prime to one another.

The second modulo calculator 250 performs an operation a mod q with respect to the output of the CRT calculator 240, a=(a₁, a₂, . . . , aₖ).

### N. Fifteenth Exemplary Embodiment

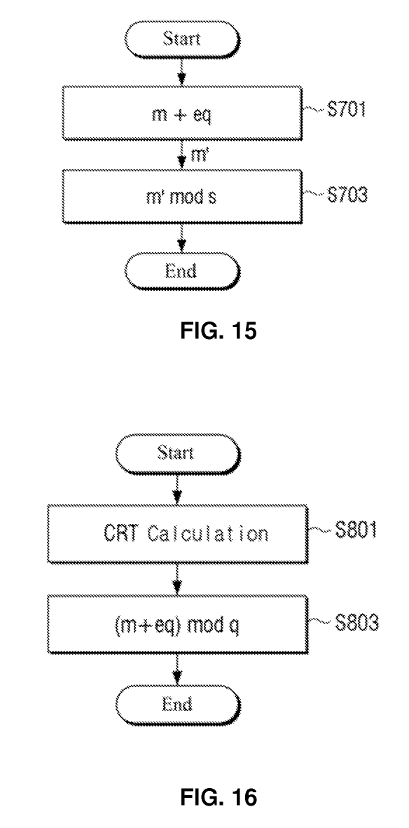

FIG. 15 is a view to illustrate an encryption method using ring isomorphism according to an exemplary embodiment.

Referring to FIG. 15, an encryption method using ring isomorphism according to an exemplary embodiment may include randomizing (S701) and calculating a modulo (S703).

The encryption method converts a plaintext (m) into a ciphertext (c), and c is calculated in the form of (c₁, c₂, . . . , cₖ).

The randomizing (S701) performs an operation m+eq with respect to the plaintext (m). The operation performed in the randomizing (S701) may be identical or similar to the operation of the randomizer 220 of FIG. 14, for example.

The calculating the modulo (S703) performs an operation (m+eq) mod s, and, as a result of calculating, the ciphertext is calculated in the form of c=(c₁, c₂, . . . , cₖ).

The operation performed in the calculating the modulo (S703) may be identical or similar to the operation of the first modulo calculator 230 of FIG. 14, for example.

### O. Sixth Exemplary Embodiment

FIG. 16 is a view to illustrate a decryption method using ring isomorphism according to an exemplary embodiment.

Referring to FIG. 16, a decryption method using ring isomorphism according to an exemplary embodiment may include CRT calculating (S801) and calculating a modulo (S803).

The CRT calculating (S801) outputs a value by applying the Chinese Remainder Theorem to the ciphertext (c) using equation 7, and the output value may have the form of m+eq.

The operation performed in the CRT calculating (S801) may be identical or similar to the operation of the CRT calculator 240 of FIG. 14, for example.

The calculating the modulo (S803) performs an operation (m+eq) mod q, thereby calculating a plaintext.

The operation performed in the calculating the modulo (S803) may be identical or similar to the operation of the second modulo calculator 250 of FIG. 14, for example.

### P. Seventeenth Exemplary Embodiment

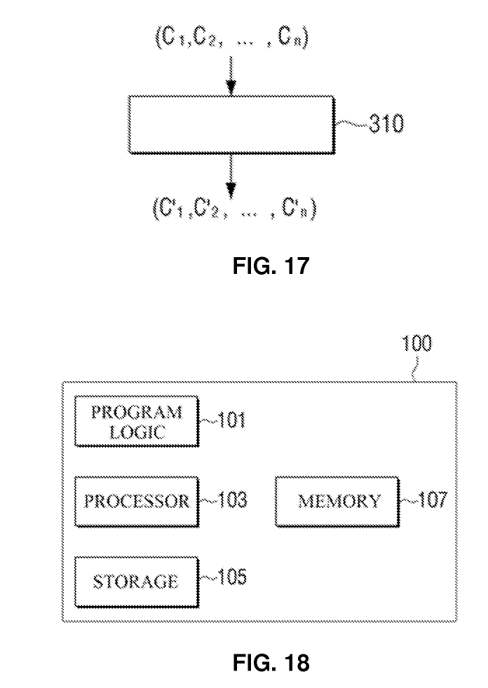

FIG. 17 is a view to illustrate a refresh apparatus according to an exemplary embodiment.

Referring to FIG. 17, a refresh apparatus 310 according to an exemplary embodiment receives a ciphertext (c), performs a refresh operation, and calculates a new ciphertext (c′).

The ciphertext (c) input to the refresh apparatus 310 is a ciphertext as a result of repeating multiplication and addition among ciphertexts, and such a ciphertext (c) contains an error. For the convenience of explanation, the ciphertext (c) is assumed as c=(c₁, c₂, . . . , cₙ).

The ciphertext (c′) output from the refresh apparatus 310 is a ciphertext from which the error is removed, and is in a state in which it can be multiplied or added again.

The refresh apparatus 310 according to an exemplary embodiment requires the following assumptions:

1) Ciphertext c=(c₁, c₂, . . . , cₙ), cᵢ∈{0, 1}

2) Secret Key s=(a₁, a₂, . . . , aₖ), aᵢ∈{0, 1}

3) Decrypting process should have the following process:

$$m = f ( c ) = {\sum }_{j = 0}^{n + 1} {λ}_{j} {\prod }_{i = 0}^{n} ( {a}_{j} + {s}_{i} {c}_{i} )$$

where λⱼ and aⱼ are known constants.

Related-art Gentry and Halevi suggested fully homomorphic encryption schemes that can perform bootstrapping without squashing when a decryption circuit has a special shape. One of the fully homomorphic encryption schemes is to perform binary expansion with respect to a secret key (e) used in the Elgamal encryption, and evaluate the decryption circuit homomorphically. The refresh apparatus 310 according to an exemplary embodiment improves such a method.

That is, the Gentry and Halevi perform binary expansion with respect to the secret key (e) as follows:

$${y}^{e} = y {\sum }_{l = 0}^{[ log e ]} {e}_{l} {2}^{l} = {\prod }_{l = 0}^{[ loge ]} {y}^{{el2}^{i}} = {\prod }_{l = 0}^{[ loge ]} ( {e}_{l} ( {y}^{{2}^{l}} - 1 ) + 1 )$$

Herein, when encryption of e_l is added to the public key, ŷe may be evaluated homomorphically. This means that the decryption circuit of the Elgamal encryption can be evaluated homomorphically. However, in this case, the shortcoming is that homomorphic capacity of given homomorphic encryption (a number of supportable multiplications) should be increased to 4 lambda. The Gentry and Halevi suggested that the size of the parameter of the homomorphic encryption should be increased in order to overcome this shortcoming. However, in this case, the entire efficiency of the encryption algorithm may be reduced.

The refresh apparatus 310 according to an exemplary embodiment uses the method suggested by the Gentry and Halevi, but expands the secret key (e) as follows:

$${y}^{e} = y {\sum }_{l = 0}^{[ {log}_{ω} e ]} {e}_{l}^{′} {ω}^{l} = {\prod }_{l = 0}^{[ {log}_{ω} e ]} {y}^{{e}_{l}^{′} {ω}^{l}} = {\prod }_{l = 0}^{[ {log}_{ω} e ]} ( {\sum }_{k = 0}^{ω - 1} {{e}_{lk}^{′} ( {y}^{{ω}^{i}} )}^{k} )$$

By doing so, the homomorphic capacity of the homomorphic encryption is reduced through general natural number w system expansion of the secret key (e) rather than binary expansion. The homomorphic capacity can be reduced from 4 lambda by 4 lambda/log w (multiplication should be performed as much as a product of e_{l k}′ and {ŷ{ŵl}}̂, and log_w e), such that bootstrapping can be achieved without increasing parameters of the homomorphic encryption and without squashing.

According to an exemplary embodiment, the refresh apparatus 310 may be included in an encryption apparatus, a decryption apparatus, or a calculation apparatus.

FIG. 18 is a view to illustrate a computer system to which an encryption apparatus, a decryption apparatus, and/or a calculation apparatus according to an exemplary embodiment is applied.

The exemplary embodiments described above with reference to FIGS. 1 to 10 and FIGS. 11 to 17 may be implemented in the computer system shown in FIG. 18, for example.

The computer system of FIG. 18 may be one of a mobile apparatus such as a smartphone or a personal digital assistant (PDA) and a computer system such as a desktop PC, a tablet PC, or a server, but is not limited to these computer systems.

The encryption apparatus or method, the decryption apparatus or method, the calculation apparatus, or the refresh apparatus described above with reference to FIGS. 1 to 10 and FIGS. 11 to 17 may be implemented in the computer system of FIG. 18.

Referring to FIG. 18, the computer system 100 includes a program logic 101, a computer processor 103, a storage 105, and a memory 107.

The program logic 101 may be implemented in the form of a code that is executable in a computer, and may be stored in the storage 105 and may be loaded into the memory 107 under the control of the computer processor 103 to be operated.

For example, the program logic 101 may include a code to perform the operations of the randomizer 20 and/or the converter 30 described above with reference to FIG. 1. Alternatively, at least one of the randomizer 20 and the converter 30 may be implemented as hardware.

For another example, the program logic 101 may include a code to perform the operations of the evaluator 40 and the modulo calculator 50 described above with reference to FIG. 2. Alternatively, at least one of the evaluator 40 and the modulo calculator 50 may be implemented as hardware.

For example, the program logic 101 may include a code to perform the operations of the modulo calculator 10, the randomizer 20, and/or the converter 30 described above with reference to FIG. 4. Alternatively, at least one of the modulo calculator 10, the randomizer 20, and the converter 30 may be implemented as hardware.

For example, the program logic 101 may include a code to perform the operations of the evaluator 40, the first modulo calculator 50, and the second modulo calculator 60 described above with reference to FIG. 5. Alternatively, at least one of the evaluator 40, the first modulo calculator 50, and the second modulo calculator 60 may be implemented as hardware.

For example, the program logic 101 may include a code to perform the operations of the calculation apparatuses 70 and 80 described above with reference to FIG. 6. Alternatively, the calculation apparatuses 70 and 80 may be implemented as hardware.

For example, the program logic 101 may include a code to perform the encryption method described above with reference to FIG. 7.

For example, the program logic 101 may include a code to perform the encryption method described above with reference to FIG. 8.

For example, the program logic 101 may include a code to perform the decryption method described above with reference to FIG. 9.

For example, the program logic 101 may include a code to perform the decryption method described above with reference to FIG. 10.

For example, the program logic 101 may include a code to perform the operations of the encryption apparatus and the decryption apparatus described above with reference to FIG. 11. That is, the program logic 101 may include a code to perform the operations of the randomizer 120 and the evaluator 130 described above with reference to FIG. 11. Also, the program logic 101 may include a code to perform the operations of the converter 140 and the modulo calculator 150 described above with reference to FIG. 11.

For example, the program logic 101 may include a code to perform the encryption method described above with reference to FIG. 12, and/or a code to perform the decryption method described above with reference to FIG. 13.

For example, the program logic 101 may include a code to perform the operation of the encryption apparatus described above with reference to FIG. 14, or a code to perform the operation of the decryption apparatus described above with reference to FIG. 14. That is, the program logic 101 may include a code to perform the operations of the randomizer 220 and the modulo calculator 230 described above with reference to FIG. 14. Also, the program logic 101 may include a code to perform the operations of the CRT calculator 240 and the modulo calculator 250 described above with reference to FIG. 14.

For example, the program logic 101 may include a code to perform the encryption method described above with reference to FIG. 15, and/or a code to perform the decryption method described above with reference to FIG. 16.

For example, the program logic 101 may include a code to perform the operation of the refresh apparatus described above with reference to FIG. 17.

The elements implemented as a code of a program that is executable in a computer in the above-described exemplary embodiments may be implemented as hardware logic. When the elements are implemented as hardware logic, the elements may be embedded in the computer processor 104 or may be implemented as hardware separate from the computer processor 103

While exemplary embodiments have been particularly shown and described above, it will be understood by those of ordinary skill in the art that various changes in form and details may be made therein without departing from the spirit and scope of the present invention as defined by the following claims.

What is claimed is:

1. A homomorphic encryption method using ring isomorphism, the method comprising:
executing, by one or more computer processors in a computer system, program logic loaded in a memory of the computer system to cause the computer system to perform operations, the operations comprising:
randomizing a plaintext (m) by adding an error (e) to the plaintext (m); and
converting randomized data (r) to r′ using the following equation:
Ψ:R→R′
where r∈R, r′∈R′, and the function (Ψ) is ring isomorphism.

2. The homomorphic encryption method as claimed in claim 1, wherein the randomizing comprises calculating using the following equation:
r=m+e·q,
where m is a plaintext, e·q is a component-wise product of a vector e and a vector q, e={eᵢ|1≦i≦k, i and k are positive integers}=(e₁, e₂, . . . , eₖ), q={qᵢ|1≦i≦k, i and k are positive integers}=(q₁, q₂, . . . , qₖ), and qᵢ is positive integers which are relatively prime to one another.

3. The homomorphic encryption method as claimed in claim 1, wherein the R is defined as Z^{k}ₙ (a set of least residues of a modulo n, n is a positive integer)=(r₁, r₂, . . . , rₖ), the R′ is defined as a set comprising r′=Zₙ[x]/(p(x))=f(x) as an element, and f(x) is a polynomial satisfying f(aᵢ)=rᵢ,
wherein the converting comprises obtaining the f(x) using the Lagrange interpolation,
wherein a₁, a₂, . . . , aₖ are elements of a function that is defined as S={aᵢ|aᵢ−aⱼ ∈{Z*ₙ}, 1≦i, j≦k, i, j, and k are positive integers}=(a₁, a₂, . . . , aₖ).

4. The homomorphic encryption method as claimed in claim 2, wherein the converting comprises converting the randomized data (r) using the following equation:
c=CRTₛ(r)
where CRT is an operator applying the Chinese Remainder Theorem, s=(a₁, a₂, . . . , aₖ), and r=(r₁, r₂, . . . , rₖ),
wherein a₁, a₂, . . . , aₖ are selected such that all qᵢ is relatively prime to b, and b is defined as b=a₁·a₂·a₃ . . . aₖ, which is a product of a₁ to aₖ.

5. The homomorphic encryption method as claimed in claim 4, further comprising calculating a modulo using the following equation:
m′=m mod q,
wherein the randomizing comprises randomizing using the following equation:
r=m′+eq=(m′+e₁q₁, m′+e₂q₂, . . . , m′+eₖqₖ).

6. A method for decrypting a ciphertext, the method comprising:
executing, by one or more computer processors in a computer system, program logic loaded in a memory of the computer system to cause the computer system to perform operations, the operations comprising:
evaluating a ciphertext (c) by applying a key (s) to the ciphertext (c); and
calculating a modulo by dividing a value calculated in the evaluating operation by q,
wherein the ciphertext (c) is a ciphertext that is encrypted in a homomorphic encryption method using ring isomorphism,
wherein the homomorphic encryption method comprises converting a plaintext (m) or a randomized plaintext to r′ using the following equation:
Ψ:R→R′
where r is a plaintext (m) or a randomized plaintext, r∈R, r′∈R′, and the function (Ψ) is ring isomorphism,
where q∈Q, Q={qᵢ|1≦i≦k, i and k are positive integers}, qᵢ is positive integers which are relatively prime to one another, S={aᵢ|aᵢ−aᵢ∈{Z*ₙ}, 1≦i, j≦k, i, j, and k are positive integers}=(a₁, a₂, . . . , aₖ).

7. The method as claimed in claim 6, wherein the randomized plaintext (m′) is randomized by the following equation:
r=m+e·q,
where e·q is a component-wise product of a vector e and a vector q, e={eᵢ|1≦i≦k, i and k are positive integers}=(e₁, e₂, . . . , eₖ), q={qᵢ|1≦i≦k, i and k are positive integers}=(q₁, q₂, . . . , qₖ), and qᵢ is positive integers which are relatively prime to one another.

8. The method as claimed in claim 6, wherein the R is defined as Z^{k}ₙ (a set of least residues of a modulo n, n is a positive integer)=(r₁, r₂, . . . , rₖ), the R′ is defined as a set comprising r′=Zₙ[x]/(p(x))=f(x) as an element, and f(x) is a polynomial satisfying f(aᵢ)=rᵢ,
wherein the converting comprises obtaining the f(x) using the Lagrange interpolation,
wherein a₁, a₂, . . . , aₖ are elements of a function that is defined as S={aᵢ|aᵢ−aᵢ ∈{Z*ₙ}, 1≦i, j≦k, i, j, and k are positive integers}=(a₁, a₂, . . . , aₖ).

9. The method as claimed in claim 7, wherein the converting comprises converting the randomized plaintext (r) using the following equation:
c=CRTₛ(r)
where CRT is an operator applying the Chinese Remainder Theorem, s=(a₁, a₂, . . . , aₖ), and r=(r₁, r₂, . . . , rₖ),
wherein a₁, a₂, . . . , aₖ are selected such that all qᵢ is relatively prime to b, and b is defined as b=a₁·a₂·a₃ . . . aₖ, which is a product of a₁ to aₖ.

10. The method as claimed in claim 9, further comprising calculating a modulo using the following equation:
m′=m mod q,
wherein the randomizing comprises randomizing using the following equation:
r=m′+eq=(m′+e₁q₁, m′+e₂q₂, . . . , m′+eₖqₖ).

11. A homomorphic encryption apparatus using ring isomorphism, the homomorphic encryption apparatus comprising a converter configured to convert a plaintext or data (r) which is a randomized plaintext to r′ using the following equation:
Ψ:R→R′
where r∈R, r′∈R′, and the function (Ψ) is ring isomorphism.

12. The homomorphic encryption apparatus as claimed in claim 11, further comprising a randomizer configured to calculate using the following equation:
r=m+e·q,
where m is a plaintext, e·q is a component-wise product of a vector e and a vector q, e={eᵢ|1≦i≦k, i and k are positive integers}=(e₁, e₂, . . . , eₖ), q={qᵢ|1≦i≦k, i and k are positive integers}=(q₁, q₂, . . . , qₖ), and qᵢ is positive integers which are relatively prime to one another.

13. The homomorphic encryption apparatus as claimed in claim 11, wherein the R is defined as Z^{k}ₙ (a set of least residues of a modulo n, n is a positive integer)=(r₁, r₂, . . . , rₖ), the R′ is defined as a set comprising r′=Zₙ[x]/(p(x))=f(x) as an element, and f(x) is a polynomial satisfying f(aᵢ)=rᵢ,
wherein the converter obtains the f(x) using the Lagrange interpolation,
wherein a₁, a₂, . . . , aₖ are elements of a function that is defined as S={aᵢ|aᵢ−aᵢ ∈{Z*ₙ}, 1≦i, j≦k, i, j, and k are positive integers}=(a₁, a₂, . . . , aₖ).

14. The homomorphic encryption apparatus as claimed in claim 12, wherein the converter is configured to convert the randomized data using the following equation:
c=CRTₛ(r)
where CRT is an operator applying the Chinese Remainder Theorem, s=(a₁, a₂, . . . , aₖ), and r=(r₁, r₂, . . . , rₖ),
wherein a₁, a₂, . . . , aₖ are selected such that all qᵢ is relatively prime to b, and b is defined as b=a₁·a₂·a₃ . . . aₖ, which is a product of a₁ to aₖ.

15. The homomorphic encryption apparatus as claimed in claim 14, further comprising a modulo calculator configured to calculate a modulo using the following equation:
m′=m mod q,
wherein the randomizer is configured to randomize using the following equation:
r=m′+eq=(m′+e₁q₁, m′+e₂q₂, . . . , m′+eₖqₖ).

16. An apparatus for decrypting a ciphertext, the apparatus comprising:
an evaluator configured to evaluate a ciphertext (c) by applying a key (s) to the ciphertext (c); and
a modulo calculator configured to calculate a modulo by dividing a value calculated by the evaluator by q,
wherein the ciphertext (c) is a ciphertext that is encrypted in a homomorphic encryption method using ring isomorphism,
wherein the homomorphic encryption method comprises encrypting a plaintext or data (r) which is a randomized plaintext into r′ using the following equation:
Ψ:R→R′
where r∈R, r′∈R′, and the function (Ψ) is ring isomorphism.

17. The apparatus as claimed in claim 16, wherein the randomized plaintext is randomized by the following equation:
r=m+e·q,
where e·q is a component-wise product of a vector e and a vector q, e={eᵢ|1≦i≦k, i and k are positive integers}=(e₁, e₂, . . . , eₖ), q={qᵢ|1≦i≦k, i and k are positive integers}=(q₁, q₂, . . . , qₖ), and qᵢ is positive integers which are relatively prime to one another

18. The apparatus as claimed in claim 16, wherein the R is defined as Z^{k}ₙ (a set of least residues of a modulo n, n is a positive integer)=(r₁, r₂, . . . , rₖ), the R′ is defined as a set comprising r′=Zₙ[x]/(p(x))=f(x) as an element, and f(x) is a polynomial satisfying f(aᵢ)=rᵢ,
wherein the encrypting comprises obtaining the f(x) using the Lagrange interpolation,
wherein a₁, a₂, . . . , aₖ are elements of a function that is defined as S={aᵢ|aᵢ−aᵢ ∈{Z*ₙ}, 1≦i, j≦k, i, j, and k are positive integers}=(a₁, a₂, . . . , aₖ).

19. The apparatus as claimed in claim 17, wherein the encrypting comprises encrypting the randomized plaintext using the following equation:
c=CRTₛ(r)
where CRT is an operator applying the Chinese Remainder Theorem, s=(a₁, a₂, . . . , aₖ), and r=(r₁, r₂, . . . , rₖ),
wherein a₁, a₂, . . . , aₖ are selected such that all qᵢ is relatively prime to b, and b is defined as b=a₁·a₂·a₃ . . . aₖ, which is a product of a₁ to aₖ.
